(19) United States
(12) Patent Application Publication
(10) Pub. No.: US 2017/0262508 A1
(43) Pub. Date: Sep. 14, 2017

(54) INFRASTRUCTURE MANAGEMENT SYSTEM HAVING SCALABLE STORAGE ARCHITECTURE

(71) Applicant: CA, Inc., New York, NY (US)

(72) Inventor: Julio Cesar Garcia, Fort Collins, CO (US)

(21) Appl. No.: 15/065,677

(22) Filed: Mar. 9, 2016

(51) Int. Cl. G06F 17/30; H04L 12/26; H04L 5/00

(52) U.S. Cl. CPC G06F 17/30525; H04L 5/0048; H04L 43/045; G06F 17/30864

(57) ABSTRACT

Techniques for processing infrastructure management data within a service domain are disclosed. The service domain includes service nodes that monitor respective target entities and that generate measurement data for target entities within the service domain. A database engine reads a serial measurement data stream that is generated by at least one of the service nodes. In response to reading the serial measurement data stream, the database engine generates a sequence of measurement data records that each contain target entity measurement data. The generated measurement data records further include metadata summary values and are recorded in a measurement database table in a logical access sequence that corresponds to the order in which the service nodes generated the measurement data.

### BACKGROUND

The disclosure generally relates to the field of distributed data processing and storage, and more particularly to a scalable storage architecture for collecting, processing, and storing infrastructure management data.

Computer infrastructure management (IM) systems are utilized to identify, monitor, and manage application components, devices, and subsystems within data processing and network infrastructures. As part of monitoring, IM systems are utilized to detect and track performance metrics (e.g., QoS metrics) and other measurement data (e.g., available storage capacity) within data processing and networking systems. IM systems typically include an infrastructure management database (IMDB) that records components, devices, and subsystems (IT assets) as well as descriptive relationships between the assets. The IMDB also stores performance metrics associated with the components, devices, and subsystems. Agent-based or agentless services are utilized to collect the identities, connectivity configurations, and performance metrics of the IT assets.

### BRIEF DESCRIPTION OF THE DRAWINGS

Embodiments of the disclosure may be better understood by referencing the accompanying drawings.

FIG. 1 is a block diagram depicting an infrastructure management (IM) system that implements a distributed storage architecture in accordance with an embodiment;

FIG. 2 is a block diagram illustrating the internal architecture of a database engine that may be implemented in an IM system in accordance with an embodiment;

FIG. 3 is a block diagram depicting a data engine probe that interacts with a hub and a monitor service client to process probe measurement data and generate measurement database and report database records in accordance with an embodiment;

FIG. 4 is a flow diagram illustrating operations and functions for processing IM data in accordance with an embodiment;

FIG. 5 is a flow diagram depicting operations and functions for processing IM data in accordance with an embodiment; and

FIG. 6 is a block diagram depicting an example computer system that includes a IM storage system in accordance with an embodiment.

### DESCRIPTION

The description that follows includes example systems, methods, techniques, and program flows that embody aspects of the disclosure. However, it is understood that this disclosure may be practiced without some of these specific details. In other instances, well-known instruction instances, protocols, structures and techniques have not been shown in detail in order not to obfuscate the description.

### INTRODUCTION

The disclosures herein describes techniques for monitoring the operations of an IT system that may comprise computer hardware, software, networking components, etc. In some embodiments, a service domain includes multiple monitor service nodes for detecting and tracking performance metrics and availability of hardware, firmware, and software in the service domain. For example, service monitor nodes may be configured as a monitor services cluster or may operate mutually independently. The performance metrics and other measurement data may include direct metrics such as recorded processing speed, link throughput associated with operations of the components, devices, subsystems, and systems (target entities) within a service domain. The service domain includes a management server that may include a database engine for collecting and recording the performance and availability metrics within a report database. In some embodiments, the report database may comprise a centralized or distributed database management system and one or more storage nodes in which report records are stored. The management server communicates with the monitor service nodes within the service domain via a messaging bus that enables different systems to communicate through a shared set of interfaces.

The service domain further comprises multiple monitor service nodes that communicate with components within the management server via the message bus. In an embodiment, database engines are deployed in one or more of the service nodes. Service node storage infrastructures are formed by configuring a distributed database to the service node database engines with one or more of the service node storage infrastructures shared by two or more of the service nodes.

In an embodiment, the service node storage infrastructures process measurement data streams from one or more monitoring probes deployed from the service nodes. The service node database engines generate sequences of measurement data records based on content within the measurement data streams. The service node database engines are configured to include inline processors that generate metadata summary values that are inserted into one or more of the measurement data records. The measurement data records are stored within the corresponding distributed database from which reports may be generated and stored as report records within the report database.

The following descriptions of service domains and IM systems include the terms “robot” and “probe” that each signify a category of program code that cooperatively function to collect data within a service domain. A probe generally represents a relatively small code item (e.g., command, query) for managing monitor service functions (“service probe”) or configured to monitor a target device (“monitor probe”) by detecting and collecting performance data or other metrics such as processing speed or available memory space (alternative referred to herein as measurement data) about the target device. For example, a probe may be configured as a monitor probe that detects CPU or memory utilization on a target host server. A robot generally refers to a type of probe that is used to schedule and manage the operations of one or more other probes, such as monitoring probes.

Example Illustrations

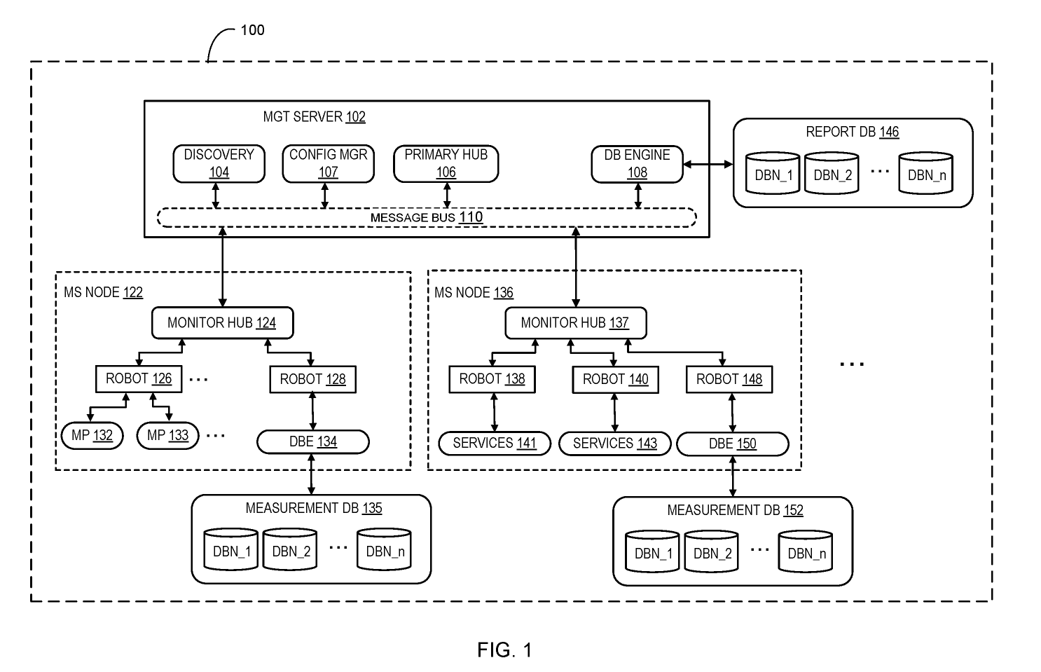

FIG. 1 is a block diagram depicting components of an IM system 100 that implements a distributed storage architecture. IM system 100 is implemented within a specified service domain comprising one or more computer and/or network systems such as a single server, a processing cluster, a data center, etc. Primary high-level functions of IM system 100 include detecting and collecting measurement data as well as providing intermediate processing of the measurement data prior to access by monitor service clients (not depicted). A “cluster” aspect of IM system 100 is embodied by multiple monitor service nodes including service nodes 122 and 136. Service nodes 122 and 136 detect and collect measurement and availability data from target infrastructure components (“target entities”) such as processors, storage components, network components, applications, etc. The IM system 100 can include additional service nodes.

Other primary functions of IM system 100 include aggregating and correlating measurement data generated or otherwise provided by service nodes 122 and 136. Correlation and aggregation functions are implemented, in part, by a management server 102, a report database 146, and measurement databases 135 and 152. Management server 102 includes a primary hub 106 and a database engine 108 that generates and sends report records to report database 146. Transmission of the measurement data between management server components such as primary hub 106, database engine 108, and monitor service nodes 122 and 136 is enabled by a message bus, conceptually represented in FIG. 1 as message bus 110. Message bus 110 comprises multiple software services that provide a publish/subscribe communication interface for components within IM system 100. Specifically, message bus 110 comprises program components that together with associated application program interfaces (APIs) enable the monitoring components (e.g., monitor service nodes 122 and 136) to intercommunicate as well as to communicate with the components within management server 102 without direct, program-to-program connections. It should be noted that while some message bus connectivity is expressly depicted in FIG. 1, additional component-to-message bus logical connectivity may be implemented.

Management server 102 further includes a discovery server 104 and a configuration manager 107. Discovery server 104 includes program instructions for deploying and communicating with corresponding discovery probes (not depicted) to identify target entities within a service domain. For instance, discovery server 104 may deploy a discovery probe within a network router to collect device IDs for devices communicating across the router. The device IDs may be retrieved by discovery server 104 from message bus 110 using a designated subscribe interface. The discovery probe may collect and discovery server 104 consequently retrieve other target entity information such as performance attributes, device category, etc. Configuration manager 107 functions in cooperation with discovery server 104 to determine target entity membership of a service domain and utilize the membership information to configure one or more monitor service nodes within IM system 100.

As shown in FIG. 1, message bus hub components are included within each of monitor service nodes 122 and 136 as well as within management server 102. A hub component is generally a software component that enables other monitor services components to connect to a message bus such as message bus 110. For instance, a hub may be a robot that binds other robots, such as robots 126, 128, 138, 140, and 148 (discussed below), into a logical group with the hub as the central connection point. A hub may similarly interconnect other hubs within a hub hierarchy. A hub may receive all or a portion of all messages posted by any message bus client component and distribute the messages to a programmatically specified set of associated subscriber client components. A hub may also track the addresses in a given monitor service domain, in addition to data about each of the target entities being monitored by the service nodes.

Management server 102 includes a primary hub 106, which comprises program instructions for communicating with monitor service nodes 122 and 136 via monitor hubs 124 and 137. Monitor hubs 124 and 137 comprise one or more program instructions for enabling access by monitor service node 122 to the publish/subscribe interface of message bus 110. Monitor hub 124 is communicatively coupled with a robot 126 that manages a set of monitoring probes including monitoring probes 132 and 133. Monitor hub 124 is further communicatively coupled with a service node database engine 134. Each of monitoring probes 132 and 133 comprises one or more program instructions (e.g., command, query, etc.) for detecting and/or collecting measurement and/or availability data from a target entity such as a memory device. The monitoring probes of monitor service node 122 are deployed within the target entity components (e.g., within a network router) as determined by the monitoring configuration. Robot 126 may be configured as a service probe that collects and disseminates the performance/availability data from the respective monitoring probes. Robot 126 further manages monitoring probes 132 and 133 by, for example, determining monitor activation intervals. Robot 126 may include a controller that maintains and manages monitoring probes 132 and 133 and a spooler that receives messages from the monitoring probes.

Monitoring probes 132 and 133 are independently operating agent-type monitor probes deployed by monitor service node 122 within various target entity components such as network switches or routers. As an alternative form of infrastructure monitoring mechanism, IM system 100 further includes agent-less monitor service nodes such as service node 136, which in contrast to service node 122 does not utilize independent monitoring agents. Instead, service node 136 deploys service sets 141 and 143 via robots 138 and 140, respectively. Service sets 141 and 143 are configured to instantiate multiple services comprising program instructions for detecting and collecting performance metrics from target entities. In an embodiment, service sets 141 and 143 instantiate the services within the processing systems (e.g., system memory) of respective service host target entities (e.g., server systems). Furthermore, either or both of service sets 141 and 143 may instantiate monitor services that, within each respective service container, all share an execution space, thereby precluding some or all context switch interrupts that would otherwise interrupt the processing tasks performed within a given service container.

Service node 136 includes a monitor hub 137 that provides connectivity to other IM system components via message bus 110. Monitor hub 137 may include a data services module (not depicted) that comprises program instructions for organizing data received from the service sets 141 deployed by robot 138 and the service sets 143 deployed by robot 140. For instance, the data services module may comprise program instructions for determining whether one or both of service sets 141 and 143 comprise service application containers in which multiple applications threads within each container all share a same execution space. In response to determining that either service sets 141 or 143 comprise such service application containers, the data services module may transmit a message to management server 102 to record the service container attribute information in association with each of the respective monitor services nodes and/or monitor services.

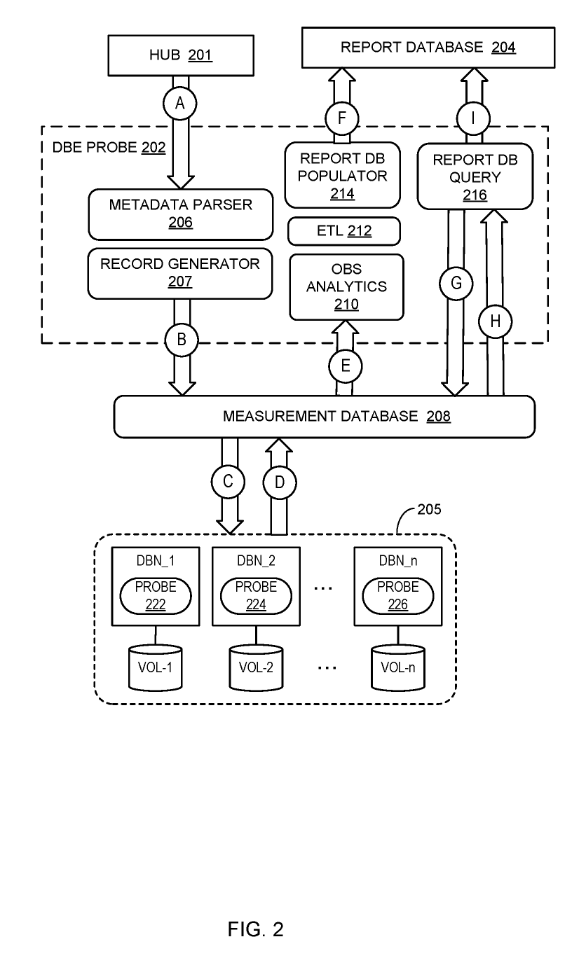

Monitor service nodes 122 and 136 collect target entity measurement data and send or otherwise provide that data via message bus 110 and/or a direct network connection to be aggregated and correlated in measurement databases 135 and 152. To this end, service nodes 122 and 136 include database engines 134 and 150, respectively, which are deployed as probes and have corresponding robots 128 and 148 through which the database engines 134 and 150 send and receive measurement data to and from the respective monitor hubs. While each of service nodes 122 and 136 are depicted as including a database engine, alternative IM system configurations may deploy service nodes that share database engines deployed from other service nodes. As explained in further detail with reference to FIGS. 2-5, database engines 134 and 150 receive serial measurement data streams generated by monitor services 141 and 143 as well as from agent-based monitoring probes 132 and 133 via message bus 110.

Database engines 134 and 150 process the received measurement data streams to generate sequences of measurement data records that are stored within measurement databases 135 and 152, respectively. Measurement databases 135 and 152 are each configured in a horizontally scalable architecture comprising multiple hardware nodes, DBN_1 through DBN_n, that are preferably co-located with the server or other device in which database engines 134 and 150 operate. The processing of measurement data by database engines 134 and 150 is depicted and described in further detail with reference to FIGS. 2-5. In an embodiment, database engines 134 and 150 may communicate with database engine 108 via message bus 110 and primary hub 106. For example, database engine 108 may retrieve or otherwise obtain measurement data records and access intermediate processing results in the form of metadata summaries to generate report database records within report database 146.

FIG. 2 is a block diagram illustrating the internal architecture of a database engine that may be implemented in an IM system such as IM system 100 in accordance with an embodiment. The depicted database engine comprises a database engine (DBE) probe 202 that include program code and data utilized for processing measurement data received from service nodes. DBE 202 is communicatively coupled, such as via a messaging bus, to a hub 201, which may be a monitoring or primary hub. While only a single DBE probe is depicted to avoid obfuscation, implementations such as that shown in FIG. 1 may include multiple DBE probes that are logically coupled to respective monitoring and/or primary hubs. DBE probe 202 is further communicatively coupled to a measurement database 208 and a report database 204. The physical and/or logical communication channels between DBE probe 202 and databases 208 and 204 may be a network connection such as may be configured using an HTTP protocol.

Measurement database 208 generally includes a set of tables, naming schemas, query handlers, and other data and program constructs for organizing measurement data that are stored in a storage subsystem 205. While depicted as a discrete module in FIG. 2 for ease of illustration, the components of measurement database 208 include a database management system code and data records stored across storage devices within storage. subsystem 205. In the depicted embodiment, measurement database 208 is configured as a distributed database in which the storage devices (e.g., disk drives, solid state drives) within storage subsystem 205 are not centrally controlled by the same processing device(s). In this configuration, database program instances and data records are stored in across multiple computation and storage nodes such as virtual machines. In FIG. 2, the storages nodes are depicted as database nodes, DBN_1 through DBN_n, having respective storage volumes VOL-1 through VOL-n in which measurement data records are stored. In this configuration, measurement datasets sent by DBE probes such as DBE probe 202 can be simultaneously distributed across multiple nodes using multiple data transport channels. A distributed database such as depicted in FIG. 2 may configured within network servers such as cloud provisioned servers.

While not expressly depicted to avoid undue figure complexity, report database 204 also includes various components such as a database management system, tables, naming schemas, query handlers, and other data and program constructs for organizing measurement data that are stored in a storage subsystem. In an embodiment, report database 204 records and provides client access to secondary metric data records that have been generated based on raw measurement data records stored in measurement database 208.

The components depicted in NG. 2 cooperatively process measurement data collected in a service domain in the following manner. At stage A, DBE probe 202 retrieves or otherwise receives collected measurement data from hub 201. The measurement data may be received as a set or series of data objects each including multiple data fields that specify, for example, the monitor probe ID, a time stamp, and a measurement value such as a processing performance value. As utilized herein, the series of data objects may be referred to a probe packets. As depicted, DBE probe 202 includes a metadata parser 206 component that processes the measurement data received as a serial data stream from hub 201. More specifically, metadata parser 206 parses the data objects in the measurement data stream to identify measurement data values for respective target entities. The data objects may include individual measurements and/or log entries that each comprise multiple measurement values. The parsed data object information is passed to a database populator tool depicted in FIG. 2 as a record generator 207. In an embodiment, record generator 207 generates tables and constituent table records based on measurement values and corresponding service node source information identified from the stream of measurement data objects. For example, record generator 207 may determine to generate a new measurement data table in response to detecting that a new measurement data stream has been received.

Record generator 207 generates measurement data tables and corresponding records by sending the necessary table and/or record data (e.g., assigned object name, allocated data entries and metadata entry fields) to measurement database 208 at stage B. At stage C, the database management system of measurement database 208 issues high-speed writes to one or more of the database nodes, DBN_1 through DBN_n, within storage subsystem 205. Also at stage C, measurement database 208 may issue multiple series of raw data queries to storage subsystem 205. In an embodiment, the raw data queries comprise queries for intermediate processed data such as one or more of the metadata summary values that are recorded in one or more of the raw measurement data records. The database management system, naming schemas, replication and query handling, and other elements of database 208 may comprise a distributed database architecture such as Apache® Cassandra.

In addition to the database code and data components, the database nodes DBN_1 through DBN_n may each include respective monitor probes such as probes 222, 224, and 226, that have been installed to monitor DBN_1, DBN_2, and DBN_n, respectively. In an embodiment, the monitor probes can be used to provide feedback to measurement database 208 regarding the capacity of the currently allocated hardware and software to sufficiently handle the processing throughput and storage levels required on an on-going basis. For instance, one or more of probes 222, 224, and 226 may be scheduled by a respective service node robot (not depicted) to collect performance metrics such as buffer queue occupancy and storage consumption levels within storage subsystem 205 and transmit this measurement data to measurement database 208 at stage D.

Also at stage D, DBE probe 202 may request intermediate data results in response to and based on the raw data queries that were issued by measurement database 208 at stage C. For instance, consider a measurement data table having multiple time-ordered measurement values in each of multiple sequential records. At stage D, DBE probe 202 may request hourly and/or daily summary results, referred to herein alternately as “intermediate results” or “intermediate reports,” depending on the queries.

Next at stage E, an object store analytics module 210 fetches one or more of the raw or intermediate results from the datasets (e.g., measurement data tables distributed among DBN_1 through DBN_n) for summarization and further analytics processing. Having fetched the raw and/or intermediate measurement/performance data from storage subsystem 205 via database 208, analytics module 210 passes the data to an extract, transform, and load (ETL) module 212. ETL module 212 is configured to extract data from structured data sources or unstructured data sources. An example structured data source may be intermediate measurement data records containing measurement data values and metadata summary values. An example of unstructured data sources may be logs of measurement data values contained within raw measurement records. ETL module 212 further transforms the data for storage within a file system and/or database format utilized by report database 204 and loads the records into the database. In the depicted embodiment, the load function may be performed by a database populator tool 214 which, at stage F, further streams the measurement summary records (e.g., average of individual measurements over a specified period) and some of the raw data records to report database 204.

At stage G, a report database query module 216 generates and sends queries for structured and/or unstructured data stored within measurement database 208. In contrast to the systematic periodic summary requests at stage C, the queries at stage G may be user generated troubleshooting queries that require the non-summarized raw data values recorded within storage subsystem 205. In an embodiment, the troubleshooting queries may comprise SQL queries generated by a user, such as a system administrator. At stage H, measurement database 208 responds by sending query results to database query module 216 which forwards the results to report database 204 at stage I. In an embodiment in which report database 204 employs a relational database management system (RDBMS), the queries at stage G may be Structured Query Language (SQL) queries for accessing data objects to be recorded within database 204.

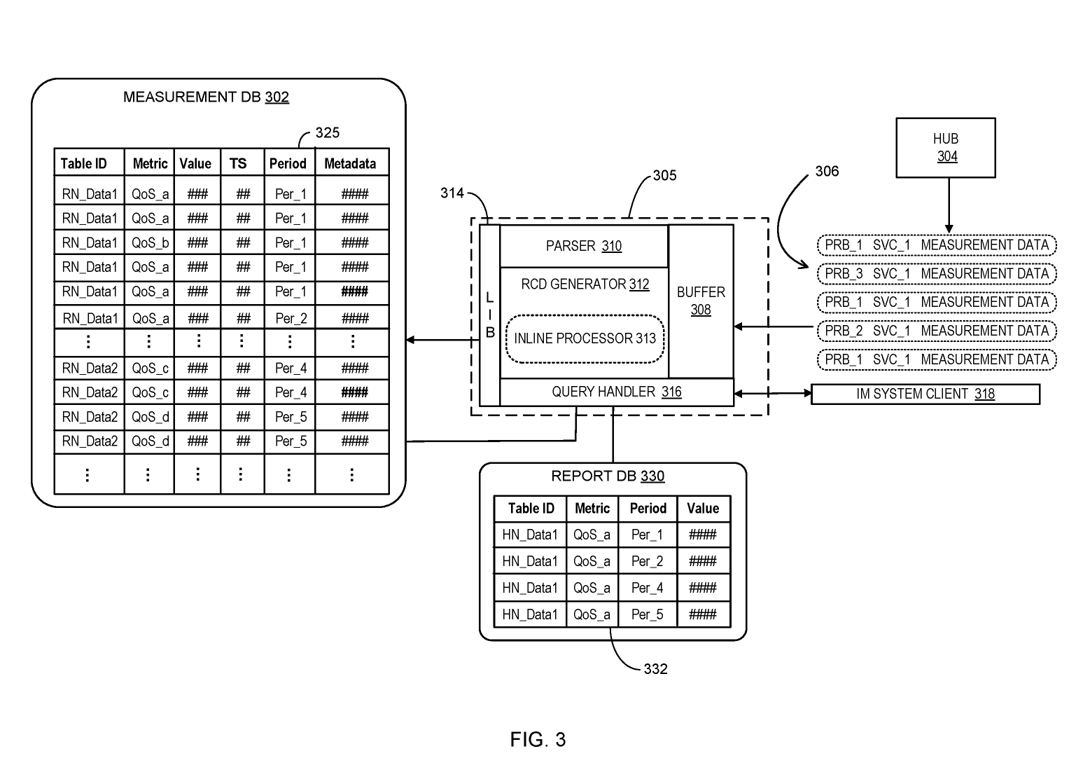

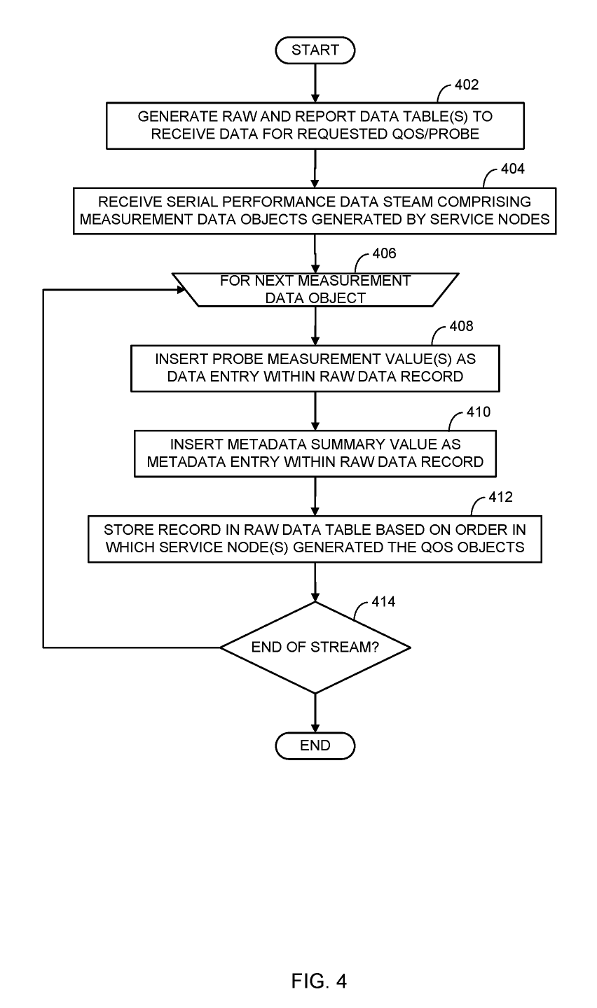

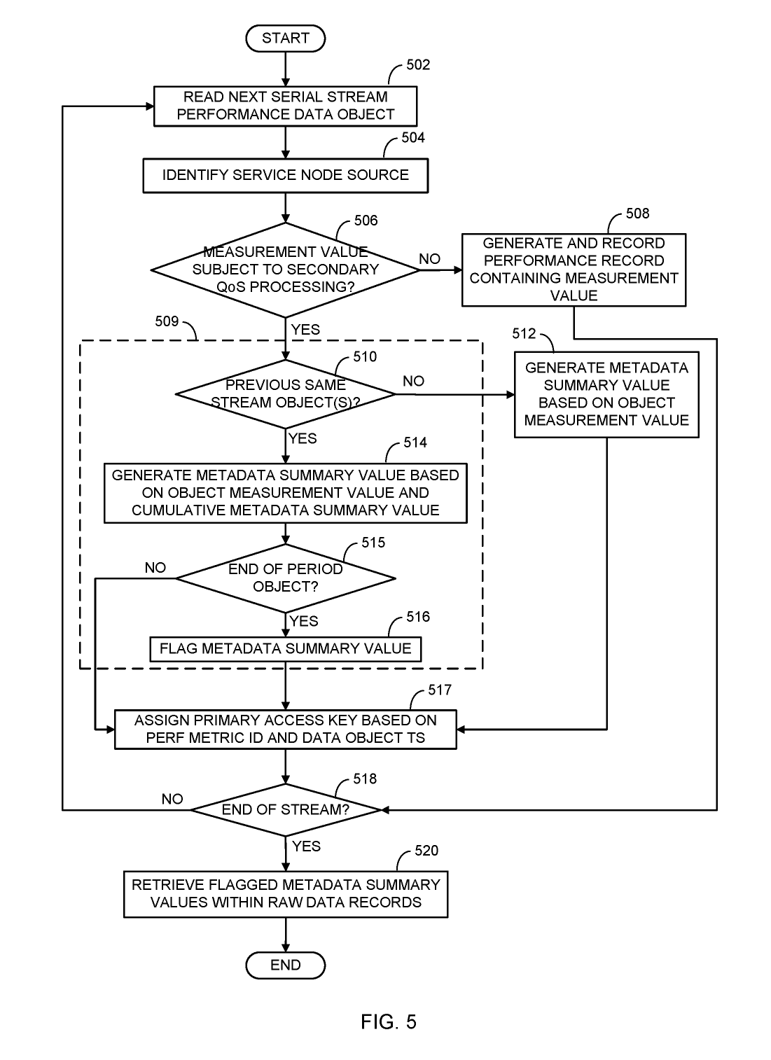

FIG. 3 is a block diagram depicting a DBE probe 305 that interacts with a hub 304 and an IM system client 318 to process probe measurement data and generate measurement database and report database records in accordance with an embodiment. DBE probe 305 may be configured as any one of the DBE probes depicted in FIGS. 1 and 2 and may perform one or more of the operations and functions described with reference to FIGS. 4 and 5. As depicted, DBE probe 305 comprises an object buffer 308, a parser 310, a record generator 312, a query handler 316, and a protocol interface library 314. The components of DBE probe 305 are configured to receive and process logically serialized streams of raw measurement data from hub 304. For example, DBE probe 305 may retrieve a set of probe measurement data objects 306 from hub 304. As shown, each of data objects 306 includes a data value, MEASUREMENT_DATA, associated with one of three probe identifiers, PRB_1, PRB_2, or PRB_3. The data value may be a structured probe measurement value, such as a numeric latency period value, or may be an unstructured data value, such as a log comprising multiple such measurement values. The probe identifier may be an alphanumeric code that uniquely identifies a corresponding monitoring probe within a service domain. Each of the depicted probe measurement data objects 306 further includes a service node identifier, SVC_1, which may be an alphanumeric code that uniquely identifies a monitor service node, such as monitor service nodes 122 and 136, within a service domain.

Object buffer 308 initially receives and processes the data objects received from hub 304. Specifically, object buffer 308 may be configured to sequentially order or re-order the incoming, physically serialized data objects based on one or both the probe ID and service node ID for optimal processing by parser 310 and record generator 312. Parser 310 is configured, using any combination of coded software, firmware, and/or hardware, to selectively identify and interpret each of the data objects and constituent data values and probe and/or service node IDs in a given data collection stream and to provide the resultant data values and identifier information to record generator 312. Parser 310 may be further configured to read and associate the respective structured and/or unstructured data values. For example, assume that a measurement data storage cycle is performed for storing the content of or data derived from the content of data objects 306 within measurement database 302. DBE probe 305 retrieves data objects 306 from hub 304 as a measurement data stream comprising individual objects to be buffered within object buffer 308 in preparation for processing by parser 310 and record generator 312. Parser 310 individually processes each of data objects 306, determining the probe IDs in logical association with the service node IDs and respective measurement data values.

Record generator 312 is configured, using any combination of coded software, firmware, and/or hardware, to map the parsed portions of the data objects into database records such as may be recorded in a measurement database 302. For example, record generator 312 includes an inline serial stream processor 313. As explained with reference to FIG. 2, the measurement database may be configured using a multi-node, distributed database architecture that is optimally suited for receiving and storing data across multiple nodes at very high input speeds. In such an environment, inline serial stream processor 313 may be configured to compute variance statistics for the measurement data values within the incoming data objects in a single pass, processing each of the data values only once. In this configuration, inline serial stream processor 313 determines and utilizes a recurrence relation between data values in the serial stream of objects from which the variance statistics can be computed in a numerically stable manner. For example, inline serial stream processor 313 may include and execute a Knuth algorithm to perform the foregoing inline processing.

Parser 310 passes the parsed data to record generator 312 which generates corresponding measurement data records to be stored as raw data records 325 in measurement database 302. As depicted, each of the generated measurement data records within data records 325 include multiple fields including a table ID field, Table ID, a metric ID, Metric, a measurement value field, Value, a timestamp field, TS, a period value field, Period, and a metadata field, Metadata. Each of raw data records 325 belongs to a respective table that is designated by the Table ID field entry. The depicted embodiment shows two such tables comprising records having Table ID field entries of RN_Data1 and RN_Data2. Record generator 312 may read the probe ID and service node ID fields of data objects 306 to determine which measurement data table the corresponding entries will be recorded within measurement database 302. For instance, record generator 312 may determine that all measurement data from service node, SVC_1, is to be recorded in measurement data table RN_Data1.

The Metric field entries in each of the records 325 may be determined or derived based on the corresponding probe ID field entry values. For example, record generator 312 determines performance metric IDs of QoS_a and QoS_b for various records for RN_Data1 and RN_Data2. QoS_a and QoS_b may represent performance metrics such as network traffic level, latency, etc. The Value field entries are determined or derived from the content of the MEASUREMENT DATA values within data objects 306. The TS field entries are determined either from an appended timestamp field within data objects 306 which may or may not be incorporated within the MEASUREMENT DATA values. Similarly, record generator 312 may determine the Period field entries based on an appended period value which may or may not be included as part of the MEASUREMENT DATA values. Record generator 312 is further configured to record each of the measurement data records 306 in a logical access sequence that corresponds to the order in which the probes or service nodes generated the measurement data. In one embodiment, the measurement data generation order may be determined by the order in which the data objects 306 are received by DBE probe 305. In an alternate embodiment, the measurement generation order may be determined by timestamp data encoded in each of the individual data objects 306. The corresponding logical access order may be based on the physical insertion order in which the records are entered into each of tables RN_Data1 and RN_Data2, for example.

Record generator 312 is further configured to process the Value field entries (i.e., the measurement data values) to generate corresponding Metadata field entry values within one or more of raw data records 325. Record generator 312 generates and inserts the Metadata field entries into each of records 325 in a sequence-specific manner. Record generator 312 identifies the particular sequences of records based on the probe ID. For example, the first, third, and fifth of data objects 306 specify a probe ID of PRB_1 and are therefore assigned by record generator 312 as belonging to a same sequence.

DBE probe 312 further includes query handler 316 which is configured, using any combination of coded software, firmware, and/or hardware, to process the intermediate results represented by the Metadata field entries to generate report records 332 within report database 330 and also to process the raw data Value results contained in each record. In one embodiment, each of the Metadata field entries is a summary metadata value that represents a cumulative QoS metric. For instance, the Metadata field entries may comprise a cumulative average latency metric that is computed by an inline processor, such as inline processor 313, from latency measurements recorded in the Value fields of data records in the same sequence of measurement data records. Consider the fourth and fifth of records 325 in which QoS_a represents a network link latency metric that is record at intervals within a one hour period represented as Per_1. During generation of the records, record generator 312 computes a Metadata value for the fourth record that is a cumulative average of latency values stored within the Value field entries for the first, second, and fourth of records 325. For example, the metadata value may be an average latency. The fifth record is the last for Per_1, and therefore contains the cumulative summary metadata value (highlighted in bold) for the average network link latency over the entire period. Similarly, the last record for QoS_c during Per_4 contains the cumulative summary metadata value (highlighted in bold) such as an average or standard deviation corresponding to whatever measurement values are recorded.

Query handler 316 may directly access the intermediate results within measurement database 302 to generate the report records within report database 330. In an embodiment query handler 316 identifies and accesses the last record for each period to obtain the cumulative metadata value for the entire period. Each of the report records includes a Table ID field designating a table, HN_Data1, over which the measurement data for a particular metric was collected over multiple periods, Per_1 through Per_5. For example, each of Per_1 through Per_5 may represent a particular hour over which raw measurements for performance metric QoS_a were collected and recorded within raw data records 302. Query handler 316 computes or otherwise determines the Value entries based, at least in part, on the summary metadata values stored within the corresponding raw data records 325.

FIG. 4 is a flow diagram illustrating operations and functions for processing infrastructure management data in accordance with an embodiment. The operations and functions depicted and described with reference to FIG. 4 may be performed by one or more of the system entities and program constructs such as the database engines (otherwise referred to herein as database engine probes) depicted with reference to FIGS. 1-3. The process begins as shown at block 402 with a database management system generating data tables includes a raw measurement data table and a report table logically configured to receive structured and unstructured data from a database engine. In an embodiment, the database management system may generate the tables in response to a table generation request from the database engine. Next, the database engine receives a serial measurement data stream that includes a series of measurement data objects generated by service nodes within a service domain (block 404). In an embodiment, the serial measurement data stream is retrieved by the database engine from a hub to which each of the service nodes report across a messaging bus.

In response to reading the serial measurement data stream, beginning at block 406, the database engine identifies individual data objects and generates a sequence of measurement data records, each corresponding to one of the individual data objects. As part of measurement record generation, the database engine inserts probe measurement values contained in the objects into each of the records as data entries (block 408). The database engine further generates and inserts a metadata summary value into one or more of each of the measurement data records (block 410). As depicted and explained with reference to FIG. 3, the metadata summary values may each comprise a cumulative QoS metric, such as an average or standard deviation, of a direct measurement value such as a connection speed metric. In this manner, the raw data records include raw data (i.e., direct measurement data) as the record value and includes intermediate data (i.e., cumulatively processed raw data) as metadata. As shown at block 412, the database engine stores each of the generated records within a raw data table in a logical access order that is based on the order in which the probes and/or service nodes generated the data objects. The record generation process continues with control returning from block 414 to block 406 until measurement data records have been generated for each of the data objects within the serial measurement data stream.

FIG. 5 is a flow diagram illustrating more detailed operations and functions for processing infrastructure management data in accordance with an embodiment. The operations and functions depicted and described with reference to FIG. 5 may be performed by one or more of the system entities and program constructs such as the database engines depicted and/or described with reference to FIGS. 1-4. The process begins as shown at block 502 with a database engine receiving and reading a next data object within a serial measurement data stream. As previously described, the database engine parses and otherwise processes each of the data objects individually and collectively to generate records that include measurement-specific data values and probe-specific cumulative metadata values. The process for determining whether and how to generate a summary metadata value for each record begins as shown at blocks 504 and 506 with the database engine determining whether or not a particular measurement value generated by a probe is subject to secondary processing. First, at block 504, the database engine identifies the source of the measurement, which in an embodiment may be a particular probe that is assigned to or otherwise logically associated with a service node. Based on the probe ID, the database engine may determine that the measurement value within the data object is not subject to secondary processing in which case a measurement data record is generated without a metadata summary value (blocks 506 and 508).

In response to determining at block 506 that the measurement value is subject to secondary processing, the database engine performs operations within superblock 509 to determine a metadata summary value for the record. The metadata summary value determination begins at block 510 with the database engine determining whether previous records contain values for the same performance metric. For instance, the database engine may identify the performance metric for a data object based on the probe ID or otherwise and determine that no previous measurement values for the performance metric have been received in the serial measurement data stream. In this case, the database engine generates a metadata summary value based solely on this first received measurement value (block 512) and assigns a primary key for the record based on the performance metric ID and the data object timestamp (block 516).

As shown at blocks 510 and 514, if previous data objects in the same stream (i.e., originating from the same monitor probe) have been received, an inline processor within the database engine generates a metadata summary value based on the measurement value contained in the object and one or more cumulative metadata summary values generated for previous data objects in the same stream. In an embodiment, the inline processor generates the metadata summary values in a per-period manner. For example, the inline processor may generate summary metadata values for a standard deviation. If recorded based on specified periods, the inline processor may generate cumulative standard deviation values for a particular measurement value in hour intervals so that the last record entry for a given hourly interval contains the last cumulative record for that hour. If, as shown at blocks 515 and 516, the data object is the last recorded object for a specified interval, the data engine flags the metadata summary value and/or the corresponding measurement record designating it as the last of the period. Record generation further includes assignment of a primary access key based on the performance metric ID and the data object timestamp (block 517). The record generation process continues as shown with control passing from block 518 back to block 502 until the end of the measurement data stream. Following raw data record generation for the entire stream, the database engine may generate report records in which period-specific QoS values such as average latency can be retrieved as the records containing the flagged metadata summary values (block 520).

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

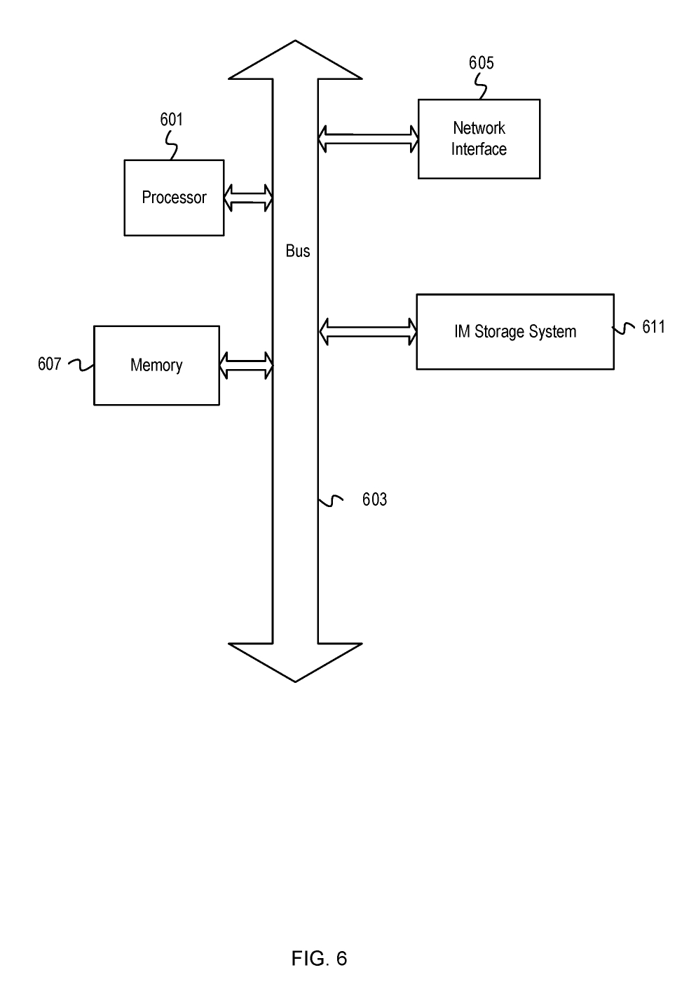

FIG. 6 depicts an example computer system that implements monitor services cluster configuration in accordance with an embodiment. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes an IM storage system 611. The IM storage system 611 provides program structures for collecting, storing, and processing probe measurement information within storage and report database data structures. The measurement information is recorded in raw data records that include measurement data entries and summary metadata entries. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for an object storage backed file system that efficiently manipulates namespace as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

What is claimed is:

1. A method for processing infrastructure management data within a service domain which include service nodes that monitor respective target entities, said method comprising:
generating, by the service nodes, measurement data for target entities within the service domain;
reading a serial measurement data stream that is generated by at least one of the service nodes;
in response to reading the serial measurement data stream, generating a sequence of measurement data records that each contain target entity measurement data, wherein said generating the sequence of measurement data records includes inserting a metadata summary value into at least one of the sequence of measurement data records; and
recording the sequence of measurement data records, including the at least one measurement data record having the inserted metadata summary value, into a database table in a logical access sequence that corresponds to the order in which the service nodes generated the measurement data.

2. The method of claim 1, wherein said generating the sequence of measurement data records further comprises assigning primary access keys to at least one of the measurement data records, including the at least one measurement data record having the inserted metadata summary value, wherein each of the primary access keys associates a performance metric ID with a timestamp.

3. The method of claim 2, wherein said generating the sequence of measurement data records further comprises assigning secondary access keys to respective subsets of the measurement data records, wherein the secondary access keys specify a monitoring collection period.

4. The method of claim 1, further comprising:
determining the metadata summary value for an n^{th} measurement data record within the sequence of measurement data records based on data values for measurement data records generated prior to generating the n^{th} measurement data record.

5. The method of claim 4, wherein determining the metadata summary value for the n^{th} measurement data record comprises:
parsing probe output data objects in the serial measurement data stream to identify measurement data for target entities;
processing the measurement data and statistical relations between the measurement data received in different probe output data objects using an inline data processing component; and
generating the metadata summary value in accordance with the processed measurement data and statistical relations for an m^{th} probe output data object and a specified number of probe packets preceding the m^{th} probe output data object in the serial measurement data stream.

6. The method of claim 1, wherein the service nodes each include monitoring probes that generate probe packets and a collection hub that generates the measurement data stream on a messaging bus as a sequence of the probe packets, and wherein at least one of the service nodes includes a local database engine, said reading a serial measurement data stream comprising reading, by the local database engine, a serial measurement data stream generated by a respective one or more of the service nodes.

7. The method of claim 6, wherein the database table is stored in a database storage cluster comprising multiple interconnected storage nodes, said method further comprising:
the local database engine transmitting the measurement data streams generated by the respective service nodes to the database storage cluster;
at least one of the service nodes monitoring input/output (I/O) capacity of the database storage cluster during said transmitting of the measurement data streams; and
adjusting the number of storage nodes in the database storage cluster based on the monitored I/O capacity of the database storage cluster.

8. One or more non-transitory machine-readable media having program code for processing infrastructure management data within a service domain which include service nodes that monitor respective target entities stored therein, the program code to:
generate measurement data for target entities within the service domain;
read a serial measurement data stream that is generated by at least one of the service nodes;
in response to reading the serial measurement data stream, generate a sequence of measurement data records that each contain target entity measurement data, wherein said generating a sequence of measurement data records includes inserting a metadata summary value into at least one of the sequence of measurement data records; and
record the sequence of measurement data records, including the at least one measurement data record having the inserted metadata summary value, into a database table in a logical access sequence that corresponds to the order in which the service nodes generated the measurement data.

9. The non-transitory machine-readable media of claim 8, wherein said generating a sequence of measurement data records further comprises assigning primary access keys to at least one of the measurement data records, including the at least one measurement data record having the inserted metadata summary value, wherein each of the primary access keys associates a performance metric ID with a timestamp.

10. The non-transitory machine-readable media of claim 9, wherein said generating a sequence of measurement data records further comprises assigning secondary access keys to respective subsets of the measurement data records, wherein the secondary access keys specify a monitoring collection period.

11. The non-transitory machine-readable media of claim 8, further comprising program code to:
determine the metadata summary value for an n^{th} measurement data record within the sequence of measurement data records based on data values for measurement data records generated prior to generating the n^{th} measurement data record.

12. The non-transitory machine-readable media of claim 11, wherein the program code to determine the metadata summary value for the n^{th} measurement data record comprises program code to:
parse probe output data objects in the serial measurement data stream to identify measurement data for target entities;
process the measurement data and statistical relations between the measurement data received in different probe output data objects using an inline data processing application; and
generate the metadata summary value in accordance with the processed measurement data and statistical relations for the m^{th} probe output data object and a specified number of probe packets preceding the m^{th} probe output data object in the serial measurement data stream.

13. The non-transitory machine-readable media of claim 8, wherein the service nodes each include monitoring probes that generate probe packets and a collection hub that generates the measurement data stream on a messaging bus as a sequence of the probe packets, and wherein at least one of the service nodes includes a local database engine, said program code to read a serial measurement data stream comprising program code to read, by the local database engine, a serial measurement data stream generated by a respective one or more of the service nodes.

14. The non-transitory machine-readable media of claim 13, wherein the database table is stored in a database storage cluster comprising multiple interconnected storage nodes, said non-transitory machine-readable media further comprising program code to:
transmit the measurement data streams generated by the respective service nodes from the local database engine to the database storage cluster;
monitor input/output (I/O) capacity of the database storage cluster during said transmitting of the measurement data streams; and
adjust the number of storage nodes in the database storage cluster based on the monitored I/O capacity of the database storage cluster.

15. An apparatus comprising:
a processor; and
a machine-readable medium having program code executable by the processor to cause the apparatus to,
generate measurement data for target entities within the service domain;
read a serial measurement data stream that is generated by at least one of the service nodes;
in response to reading the serial measurement data stream, generate a sequence of measurement data records that each contain target entity measurement data, wherein said generating a sequence of measurement data records includes inserting a metadata summary value into at least one of the sequence of measurement data records; and
record the sequence of measurement data records, including the at least one measurement data record having the inserted metadata summary value, into a database table in a logical access sequence that corresponds to the order in which the service nodes generated the measurement data.

16. The apparatus of claim 15, wherein the program code executable by the processor to cause the apparatus to generate a sequence of measurement data records comprises program code executable by the processor to cause the apparatus to:
assign primary access keys to at least one of the measurement data records, including the at least one measurement data record having the inserted metadata summary value, wherein each of the primary access keys associates a performance metric ID with a timestamp; and
assign secondary access keys to respective subsets of the measurement data records, wherein the secondary access keys specify a monitoring collection period

17. The apparatus of claim 15, further comprising program code executable by the processor to cause the apparatus to:
determine the metadata summary value for an n^{th} measurement data record within the sequence of measurement data records based on data values for measurement data records generated prior to generating the n^{th} measurement data record.

18. The apparatus of claim 17, wherein the program code executable by the processor to cause the apparatus to determine the metadata summary value for the n^{th} measurement data record comprises program code executable by the processor to cause the apparatus to:
parse probe output data objects in the serial measurement data stream to identify measurement data for target entities;
process the measurement data and statistical relations between the measurement data received in different probe output data objects using an inline data processing application; and
generate the metadata summary value in accordance with the processed measurement data and statistical relations for the m^{th} probe output data object and a specified number of probe packets preceding the m^{th} probe output data object in the serial measurement data stream.

19. The apparatus of claim 15, wherein the service nodes each include monitoring probes that generate probe packets and a collection hub that generates the measurement data stream on a messaging bus as a sequence of the probe packets, and wherein at least one of the service nodes includes a local database engine, said program code executable by the processor to cause the apparatus to read a serial measurement data stream comprising program code executable by the processor to cause the apparatus to read, by the local database engine, a serial measurement data stream generated by a respective one or more of the service nodes.

20. The apparatus of claim 19, wherein the database table is stored in a database storage cluster comprising multiple interconnected storage nodes, and further comprising program code executable by the processor to cause the apparatus to:
transmit the measurement data streams generated by the respective service nodes from the local database engine to the database storage cluster;
monitor input/output (I/O) capacity of the database storage cluster during said transmitting of the measurement data streams; and
adjust the number of storage nodes in the database storage cluster based on the monitored I/O capacity of the database storage cluster.
